(19) United States
(12) Patent Application Publication
(10) Pub. No.: US 2011/0195290 A1
(43) Pub. Date: Aug. 11, 2011

(54) BATTERY MODULE

(76) Inventor: Martin Holger Koenigsmann, Stuttgart (DE)

(21) Appl. No.: 12/737,905

(22) PCT Filed: Jul. 31, 2009
(86) PCT No.: PCT/EP2009/059914

§ 371 Date: Mar. 17, 2011

(30) Foreign Application Priority Data
Aug. 26, 2008 (DE) 10 2008 041 547.2

(51) Int. Cl. H01M 2/10

(52) U.S. Cl. 429/99

(57) ABSTRACT

The invention relates to a battery module having a housing with at least two batteries being disposed in the housing. At least one cooling element is disposed between the at least two batteries for deflecting the heat generated by the at least two batteries between the at least two batteries. According to the invention, at least one cooling element has a greater expansion in the direction of an x axis and in the direction of a y axis, than in the direction of a z axis, the x, y, and z axes forming a rectangular coordinate system. Furthermore, the at least one cooling element has a greater heat conductivity in the direction of the x axis and/or in the direction of the y axis than in the direction of the z axis.

The invention relates to a battery module as generically defined by the preamble to claim 1. The invention further relates to a battery module system.

### PRIOR ART

Batteries, such as nickel cadmium, nickel metal hydride, and in particular lithium-ion batteries, supply various entities, such as motor vehicles, hospitals, or power drills, with electric current. In general, a plurality of batteries are built into a housing and as a result form a battery module. Battery modules have the advantage that they can be more easily cooled with a cooling fluid, and that higher electrical outputs can be achieved by combining a plurality of battery modules into a battery module system.

In most technical applications, battery modules and battery module systems should be capable of making the highest possible electrical power or energy per unit of volume available. The power or energy density has to be maximized. Cylindrical batteries are known that are disposed in a housing. However, because of the cylindrical shape of the batteries, free spaces are created inside the housing, so that the space inside the housing with the batteries is not optimally utilized for maximum power density. In prismatic, planar or block-shaped batteries, the interior space inside a housing of a battery module can be optimally utilized. The batteries have flat outer surfaces, on which they can be stacked one above the other or side by side, so that no unused free spaces result. However, in this arrangement it is problematic to cool these tightly packed batteries inside the battery module. Particularly with lithium-ion batteries, the temperature difference between the batteries must be slight, for instance less than 4 Kelvins. Also in lithium-ion batteries, the temperatures must be no higher than 60! . For this reason, adequate cooling is necessary, in order not to shorten the service life of the batteries and moreover to prevent the safety risk, for instance from local overheating, and destruction of individual batteries, or a chain reaction of destruction of batteries within a battery module.

European Patent Disclosure EP 1 117 138 A1 shows a cooling structure for a prismatic battery assembly. The battery assemblies are disposed parallel to one another, so that flat side faces are positioned facing one another. Corrugated-finlike spacer units of metal are disposed between these flat side faces. The corrugated-finlike spacers serve to allow a cooling medium to be conducted between the flat side faces of the battery assemblies. With this cooling structure, additional free spaces are disadvantageously created between the flat side faces, so that the installation space cannot be optimally utilized. Moreover, it is absolutely necessary to cool the battery assembly by means of a flowing fluid.

US Patent Application 2003/0165734 A1 shows prismatic battery cells between which a disklike cooling fin of thermally conductive material is disposed. However, overheating of the batteries can disadvantageously occur, because the individual batteries can heat one another because of the high thermal conductivity of the cooling fins between the batteries.

### DISCLOSURE OF THE INVENTION

A battery module according to the invention includes at least two batteries disposed in the housing, at least one cooling element, disposed between the at least two batteries, for carrying away the heat between the at least two batteries generated by the at least two batteries, in which the at least one cooling element has a greater length in the direction of an x axis and in the direction of a y axis than in the direction of a z axis, and the x, y and z axes form a rectangular coordinate system, and the at least one cooling element has a greater thermal conductivity in W/mK (Watts per meter times Kelvins) the direction of the x axis and/or in the direction of the y axis than in the direction of the z axis.

The cooling element has a greater thermal conductivity in the direction of the x axis and/or in the direction of the y axis than in the direction of the z axis. Thus the generally disk-shaped cooling element, in the direction of the plane of the cooling element, or in other words for diversion to the outside of the batteries, has a greater thermal conductivity than between the individual batteries. As a result, the cooling element especially advantageously has two functions. First, because of the great thermal conductivity in the direction of the z axis, the cooling element can carry away the resultant heat well between the batteries. Second, because of the lesser thermal conductivity in the direction of the z axis, the cooling element thermally insulates the individual batteries from one another. This thermal insulation capability thus prevents heating or a heat buildup between the tightly packed individual batteries. The heat transfer from the batteries to the outside in the interstice between the batteries is effected well by thermal conduction, because of the different thermal conductivity as a function of the particular direction. The cooling element is capable of selectively controlling the thermal conduction as a function of the direction, so that in the direction of the x axis and y axis, or in other words in the direction of the plane, the resultant heat between the batteries is carried away especially well and quickly.

In particular, the thermal conductivity of the at least one cooling element is greater by 2 to 300 times in the direction of the x axis and/or in the direction of the y axis than in the direction of the z axis. In particular, the thermal conductivity of the at least one cooling element is greater by 40 to 50 times in the direction of the x axis and/or in the direction of the y axis than in the direction of the z axis. Thus the thermal conductivity is significantly variable, so that the cooling element on the one hand makes a substantial contribution to the insulation, that is, the thermal insulation, between the batteries, and on the other, it has a very high thermal conductivity in the direction of the plane of the cooling element.

In a further feature, the thermal conductivity of the at least one cooling element in the direction of the x axis and/or in the direction of the y axis is between 50 and 500. In particular, the thermal conductivity of the at least one cooling element in the direction of the x axis and/or in the direction of the y axis is between 180 and 200 W/mK. Aluminum, for instance, has a thermal conductivity of approximately 220 W/mK. Thus the cooling element has very good thermal conductivity.

Preferably, the thermal conductivity of the at least one cooling element in the direction of the z axis is between 0 and 70. In particular, the thermal conductivity of the at least one cooling element in direction of the z axis is approximately 2 to 10 W/mK. Plastics, for instance, have a thermal conductivity of approximately 2 to 3 W/mK, so that in that direction the cooling element has a very low thermal conductivity, or in other words already has a significant thermal insulating capacity, and as a result, especially advantageously, thermal overheating of the tightly packed batteries is prevented.

In a variant, the at least one cooling element at least partly comprises graphite, in particular special graphite made from expanded graphite.

Expediently, the at least one cooling element is embodied as a disk, such as a foil, having a layer thickness of less than 1 cm. In an embodiment of the cooling element as a foil with an only slight thickness, for instance between 0 and 3 mm, the cooling element embodied as foil, for producing the battery module, can very easily be disposed between the individual batteries, and furthermore, because of the slight layer thickness, the cooling element requires only little space, so that the battery module had a very high energy or power density.

In a further embodiment, the at least two batteries on the surface, in the portions which adjoin an interstice between the two batteries having the at least one cooling element, are flat.

In particular, the at least one cooling element on the surface of the at least two batteries, in the portions which adjoin the interstice between the two batteries having the at least one cooling element), is in at least 50% contact with the at least two batteries. In general, the at least one cooling element on the surface of the at least two batteries, in the portions which adjoin the interstice between the two batteries having the at least one cooling element), is in 100% or nearly 100% contact with the at least two batteries. The contact is normally effected directly but can also be effected indirectly through a further substance, such as a contact gel. As a result, good heat conduction from the batteries to the cooling element can be ensured, and moreover the interior space in the battery module can be optimally utilized, because no free spaces are present.

In a further embodiment, the at least one cooling element has an extension, extending past the interstice between the at least two batteries, so that the heat absorbed by the at least one cooling element between the at least two batteries can be better carried away at the extension. Heat absorbed in the cooling element has to be carried away. The embodiment of the extension has the advantage that the heat, because of the larger surface area of the extension, can be better dissipated. If no extension is embodied, then the only surface area available for carrying away the heat absorbed by the cooling element is the edge or the end of the cooling element between the block-shaped batteries.

In a supplementary variant, the housing has at least one inlet opening for introducing a cooling fluid into the housing, at least one outlet opening for carrying the cooling fluid out of the housing, and part of the at least one cooling element, in particular the extension, can be put into contact with the cooling fluid for carrying away the heat.

In a further variant, the battery is a lithium-ion battery, and/or the cooling fluid is air, water, glycol, or oil, such as silicone oil.

Instead of the diversion of the heat absorbed by the cooling element by a cooling fluid by means of convection, the absorbed heat can also be absorbed by means of thermal radiation and/or thermal conduction. For instance, it is possible for only a nonmoving, static liquid to be disposed in the housing, which liquid carries away the heat not by convection but by means of thermal conduction. The liquid can absorb heat and thus serve to intercept heat peaks and to make the operating temperatures of the batteries more homogeneous. Moreover, the possibility exists of merely recirculating this liquid in order to achieve a homogeneous temperature distribution.

When the batteries are cooled by means of a flowing cooling fluid, fluid conducting devices can be inserted inside the housing that make the fluid turbulent and thus make a more-homogeneous temperature distribution possible. If a liquid is used, such as water, glycol or silicone oil, it can serve not only to carry away the heat but also, in the event of a malfunction, it can act as a fire extinguishing medium for the batteries or can prevent a fire or explosion.

Both the cooling element and the cooling fluid can serve the purpose not only of cooling but also to heat the batteries of the battery module to an optimal operating temperature. The cooling fluid is heated by a preferably electric heater. A battery management system controls and/or regulates the temperature as a function of the operating state of the batteries and heats or cools the batteries as a function of the operating state necessary or present just at that time. For that purpose, a control and regulating device and/or at least one sensor, in particular a temperature sensor, is normally used.

Expediently, the housing is of metal or plastic.

A battery module system according to the invention having a plurality of battery modules includes at least one battery module as described above.

One exemplary embodiment of the invention will be described in further detail below in conjunction with the accompanying drawings. In the drawings:

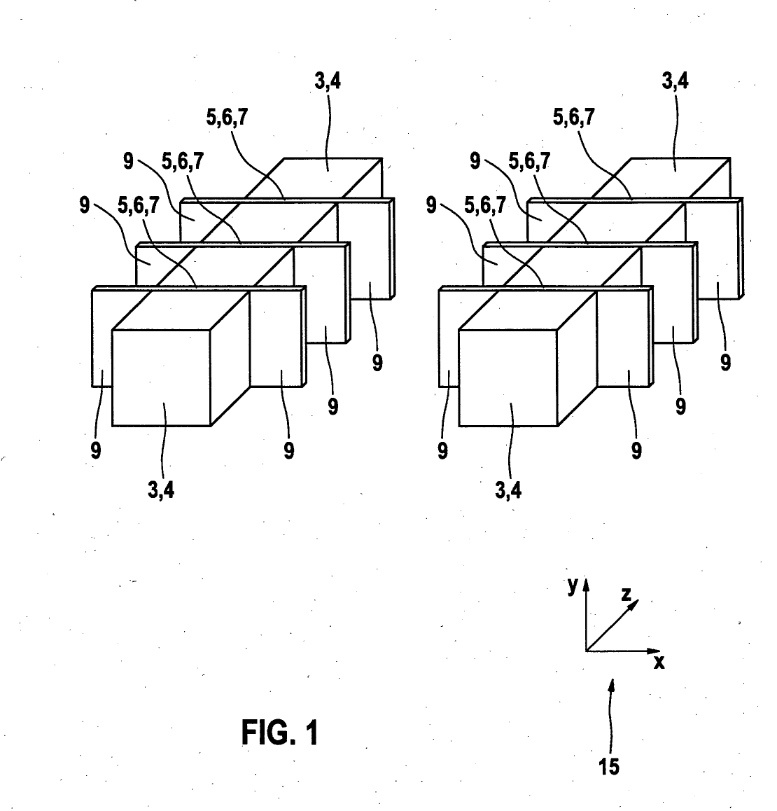

FIG. 1 is a perspective view of the batteries with cooling elements of a battery module, without the housing;

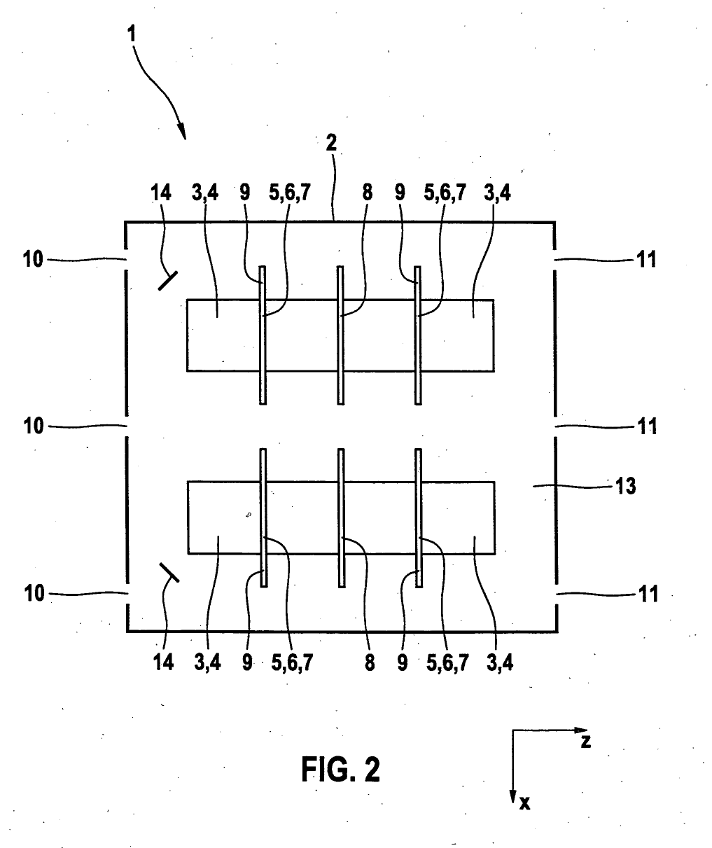

FIG. 2 is a schematic longitudinal section through the battery module of FIG. 1; and

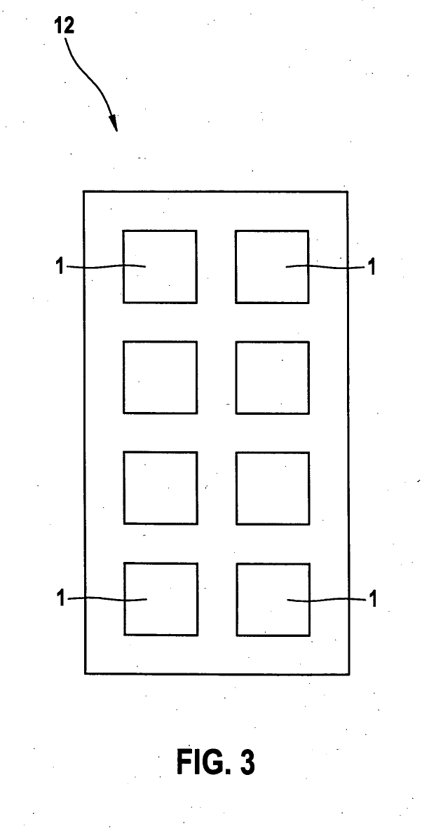

FIG. 3 is a highly schematic longitudinal section through a battery module system.

In FIG. 1, a perspective view of the batteries 3 of a battery module 1 is shown. The batteries 3 are disposed in a housing 2, but the housing 2 is not shown in FIG. 1. The batteries 3 are block-shaped. One cooling element 5 is disposed between respective side faces of each of the block-shaped batteries 3. The cooling element 5 is a disk 6 and has a layer thickness in the range of from 2 to 3 mm. Because of the easy deformability and in particular flexibility, the cooling element 5 is also a foil 7. The cooling element 5 comprises a special graphite for selective thermal conduction. The cooling element 5, in the direction of an x axis and a y axis of a coordinate system 15, has a thermal conductivity in W/mK that is 40 to 50 times greater than in the direction of the z axis of the coordinate system 15. The thermal conductivity in W/mK in the direction of the x axis and y axis, in the direction of the plane of the cooling element 5, is approximately 180 to 200 W/mK. In a direction perpendicular to the plane, that is, in the direction of the z axis of the coordinate system, the thermal conductivity of the cooling element is approximately 4 to 6 W/mK.

Thus the heat in an interstice 8 between the batteries in which the cooling element 5 is disposed, which heat is created in the batteries 3 embodied as lithium-ion batteries 4, can be selectively carried away by the cooling element 5 (FIGS. 1 and 2). As a result, the heat created in the batteries 3 is carried away from the cooling element 5 to the extensions 9 of the cooling element 5. Because of the low thermal conductivity W/mK of the cooling element 5 in the direction of the z axis, the cooling element 5 additionally acts as an insulation between the individual batteries 3, so that over heating of the tightly packed batteries 3 inside the battery module 1 can advantageously be prevented. The extensions 9 protrude past the batteries 3 by a length of 1 to 4 cm, for instance. For cooling the batteries 3 disposed in the battery module 1, air as a cooling fluid is introduced into the housing 2 through inlet openings 10 and carried out of the housing 2 again through outlet openings 11 (FIG. 2). In the process, the cooling fluid absorbs heat created in the batteries 3 both directly from the surface of the batteries 3 and indirectly at the extensions 9. Fluid conducting devices 14 are disposed in an interior 13 of the battery module 1. The fluid conducting devices, embodied for instance as baffles, serve to make the cooling fluid turbulent and as a result to enable a homogeneous temperature distribution inside the batteries 3. The fluid conducting devices 14 can furthermore also serve to control the flow of fluid, and in particular the flow direction of the fluid, so that the volumetric flow of the cooling fluid meets the thermal requirements of the batteries 3 for cooling (FIG. 2). The air is introduced into the inlet openings 10 by means of a blower or fan, not shown.

A plurality of battery modules 1 can also be combined into a battery module system 12 (FIG. 3). The inlet and outlet openings 10, 11 of the individual battery modules 1 are connected parallel to a central air supply, such as a fan (not shown in FIG. 3). In a battery module system 12, for instance for a passenger car or utility vehicle with 8 battery modules 1, each with six lithium-ion batteries 4, there are accordingly a total of 32 lithium-ion batteries 4. The modular construction thus makes better scalability possible, since with identical battery modules 1, different electrical outputs for various applications can easily be achieved. The battery modules 1 or the battery module system 12 can be used for instance for hybrid vehicles, electric vehicles, or electric tools or power tools. Moreover, they can be considered for use as a pitch system for windmills or for storing electrical current in solar systems.

Considered overall, considerable advantages are associated with the battery module 1 of the invention. When block-shaped batteries 3 are used within a battery module 1, they can be packed very tightly, so that a high power density of the battery module 1 or battery module system 12 can be achieved. The low layer thickness and the selective thermal conductivity of the cooling element 5 makes it possible for heat between the batteries 3 to be well carried away out of the interstice 8 and also for the batteries 3 to be insulated thermally from each other at the interstice 8, so that on the one hand the heat is well carried away, and on the other, mutual overheating of the tightly packed batteries 3 is prevented.

1-12. (canceled)

13. A battery module, including a housing, at least two batteries disposed in the housing, at least one cooling element disposed between the at least two batteries which carries away heat between the at least two batteries generated by the at least two batteries, in which the at least one cooling element has a greater length in a direction of an x axis and in a direction of a y axis than in a direction of a z axis, and the x, y, and z axes form a rectangular coordinate system, wherein the at least one cooling element has a greater thermal conductivity in the direction of the x axis and/or in the direction of the y axis than in the direction of the z axis.

14. The battery module as defined by claim 13, wherein the thermal conductivity of the at least one cooling element is greater by 2 to 300 times in the direction of the x axis and/or in the direction of the y axis than in the direction of the z axis.

15. The battery module as defined by claim 13, wherein the thermal conductivity of the at least one cooling element in the direction of the x axis and/or in the direction of the y axis is between 50 and 500 W/mK.

16. The battery module as defined by claim 14, wherein the thermal conductivity of the at least one cooling element in the direction of the x axis and/or in the direction of the y axis is between 50 and 500 W/mK.

17. The battery module as defined by claim 13, wherein the thermal conductivity of the at least one cooling element in the direction of the z axis is between 0 and 70 W/mK.

18. The battery module as defined by claim 14, wherein the thermal conductivity of the at least one cooling element in the direction of the z axis is between 0 and 70 W/mK.

19. The battery module as defined by claim 15, wherein the thermal conductivity of the at least one cooling element in the direction of the z axis is between 0 and 70 W/mK.

20. The battery module as defined by claim 16, wherein the thermal conductivity of the at least one cooling element in the direction of the z axis is between 0 and 70 W/mK.

21. The battery module as defined by claim 13, wherein the at least one cooling element at least partly comprises graphite.

22. The battery module as defined by claim 20, wherein the at least one cooling element at least partly comprises graphite.

23. The battery module as defined by claim 13, wherein the at least one cooling element is embodied as a disk, such as a foil, having a layer thickness of less than 1 cm.

24. The battery module as defined by claim 22, wherein the at least one cooling element is embodied as a disk, such as a foil, having a layer thickness of less than 1 cm.

25. The battery module as defined by claim 13, wherein the at least two batteries on a surface, in portions which adjoin an interstice between the two batteries which has the at least one cooling element, are flat.

26. The battery module as defined by claim 24, wherein the at least two batteries on a surface, in portions which adjoin an interstice between the two batteries which has the at least one cooling element, are flat.

27. The battery module as defined by claim 25, wherein the at least one cooling element on the surface of the at least two batteries, in the portions of the surface which adjoin the interstice between the two batteries having the at least one cooling element, is in at least 50% contact with the at least two batteries.

28. The battery module as defined by claim 25, wherein the at least one cooling element has an extension, extending past the interstice between the at least two batteries, so that the heat absorbed by the at least one cooling element between the at least two batteries can be better carried away at the extension.

29. The battery module as defined by claim 27, wherein the at least one cooling element has an extension, extending past the interstice between the at least two batteries, so that the heat absorbed by the at least one cooling element between the at least two batteries can be better carried away at the extension.

30. The battery module as defined by claim 28, wherein the housing has at least one inlet opening for introducing a cooling fluid into the housing, at least one outlet opening for carrying the cooling fluid out of the housing, and part of the at least one cooling element, in particular the extension, can be put into contact with the cooling fluid for carrying away the heat.

31. The battery module as defined by claim 30, wherein the battery is a lithium-ion battery, and/or the cooling fluid is air, water, glycol, or oil, such as silicone oil.

32. A battery module system having a plurality of battery modules, wherein the battery module system includes at least one battery module as defined by claim 13.
